(19) United States
(12) Patent Application Publication
(10) Pub. No.: US 2009/0096238 A1
(43) Pub. Date: Apr. 16, 2009

(54) Storage apparatus for removable roof panels

(76) Inventor: Doug Misch, Coffeyville, KS (US)

Correspondence Address: DOUG MISCH, 1907 WOODLAND AVE, COFFEYVILLE, KS, 67337, US

(21) Appl. No.: 11/974,206

(22) Filed: Oct. 12, 2007

(51) Int. Cl. B60R 11/00

(52) U.S. Cl. 296/37.1

(57) ABSTRACT

A removable roof panel storage apparatus for Jeep vehicles wherein the removable roof sections are stored within a semi soft storage apparatus with hinged support members for ease of loading roof panels, furthermore separated by a spacer of a semi-soft panel for protecting each panel, and additionally having a plurality of straps and or other fastening means utilizing a Velcro or like attachment means attached to the roof panel storage apparatus wherein the invention is designed and configured to conform to an interior compartment of a Jeep model vehicle and to securely hold the removable roof panels within the interior compartment and to be adaptable to either front of back seat attachment while additionally having a carrying means for ease of removal of said roof panel and storage apparatus from the vehicle for external storage.

### BACKGROUND OF THE INVENTION

1. Field of the Invention

The present invention relates to storage apparatus utilized for removable roof panels, and more particularly to a roof panel storage apparatus utilized for one or more roof panels on a Jeep vehicle wherein said storage apparatus may be used to safely and securely store Jeep hard top removable roof panels conveniently in the rear of the Jeep vehicle without damage to the panels.

2. Description of the Related Art

A number of Jeeps are equipped with hardtop roof structures that have removable or detachable roof panels or inserts. These hardtop roof structures permit the Jeep enthusiast to partially or completely open the cockpit or passenger area of the vehicle by removing one or both of the roof panels from the hardtop roof structure. Once the roof panels are removed from the Jeep, the driver and or passengers can enjoy driving or riding in an open air vehicle with the feeling of a being in a convertible or open air vehicle. The hardtop removable roof panel is generally made of a fiberglass, metal or some other rigid plastic like structure that may be black, see-thru or may match the exterior paint of the automobile. Usually, the Jeep enthusiast will want to carry the removable roof panels in the vehicle during a drive in order to adapt the vehicle to inclement weather conditions that may arise and to provide additional security when the

Many hardtop automobiles and sports cars that come with removable roof panels may include an interior compartment for storing the removable roof panels. Unfortunately, Jeep has no such interior compartment for storing the removable roof panels and Jeep only provides an inferior cloth bag for storing the hardtop removable roof panels that allow the roof panels to rub against each other causing damage to the panels. The current provided storage apparatus creates an unnecessary risk that the surface of the hardtop removable roof panels will become scratched and or dented as the roof panels vibrate and rub against each other thereby causing damage to the top roof panels.

Hence, the Jeep enthusiast may have to leave one or more of the roof panels in an alternative location, such as a garage, where the roof panel can also be knocked over and or damaged by foreign objects coming into contact with the removable roof panel. This also causes an inconvenience to the Jeep enthusiast.

For these reasons and more, there is a need for a roof panel storage apparatus that will safely store and secure both removable roof panels while also providing additional storage space for luggage in the interior of the Jeep rear compartment, while also preserving the originality of the Jeep look and design. Furthermore there is a need for a storage apparatus that can be easily removed from the Jeep to facilitate the storing of one or more of the removable roof panels outside the Jeep.

### SUMMARY OF THE INVENTION

The present invention is directed to a new and novel semi-soft storage apparatus for storage of Jeep removable roof panels. The storage apparatus satisfies the need to safely store and safely secure a pair of removable roof panels without damage, while preserving the originality of the Jeep. Furthermore, the present invention satisfies the need for a high quality and durable storage apparatus that can be easily removed from the interior of the jeep and placed outside the vehicle to safely store the removable roof panels without fear of damage to said panels.

The roof panel storage apparatus comprises of a specialized storage bag like structure formed to comply with the interior form, shape and color of the Jeep interior. The storage apparatus construction furthermore including a soft hinged protective cover, a separation panel, and a means for attaching the storage apparatus to the back of the rear or front seats by means of a series of straps that easily attach to the existing roll bars with Velcro strips or like attachment means that secure the storage apparatus to the back of the seat. The storage apparatus shall furthermore include a carrying means such as a strap or handle like means to carry the roof panel storage apparatus away from the jeep.

The roof panel storage apparatus includes a base member, a top member, and at least one separating support member that shall be joined between the base and top members such that the base and top members are separated by a distance substantially equal to the distance or one removable roof member wherein each member is hinged by a common spine or support means.

A protective and semi-soft or soft cover surface is disposed on the interior surface of at least one member of the removable roof panel storage apparatus, but preferably all surfaces so that the roof panels are protected during storage and are protected from the elements as well as being protected against surface scratches from the other enclosed roof panels.

The roof panel storage apparatus is furthermore designed to fit in a complementary fashion to the interior rear compartment of the Jeep and furthermore the roof panel storage apparatus is arranged as to stand up against the back of the rear seat providing for additional luggage and or utility storage space.

Additionally, if the back seat is removed, the removable roof panel storage apparatus may be stored in the interior compartment of the Jeep as to stand up against the back of the front seat when the rear seat in removed wherein the same attachment means will be utilized.

Accordingly, the roof panel storage bag is designed and configured to generally conform to and frictionally engage the interior compartment of the Jeep. The removable roof panel storage apparatus is designed so that the roof panel rack is maintained and held in position relevant to the interior compartment allowing for additional storage space within the compartment.

Advantageously, this type of configuration eliminates the need to install anchored or un-removable connectors or fastening means to the interior compartment. Therefore, preserving the original appearance of the automobile when the roof storage apparatus is removed from the interior compartment.

A further aspect of the invention is to provide ease of attachment and removal of the roof panel storage apparatus for quick use and or removal. The invention provides for improved elements and arrangements thereof for the purposes described which are new, novel, inexpensive, dependable and fully effective in accomplishing their intended purposes.

A clear understanding of the present invention will become more readily apparent upon further view of the following specification and drawings.

### BRIEF DESCRIPTION OF THE DRAWINGS

FIG. 1 shows the front view of the invention.

FIG. 2 show an end view as taken from FIG. 1.

FIG. 3 shows a perspective view of the invention in use.

### DETAILED DESCRIPTION OF THE PREFERRED EMBODIMENTS

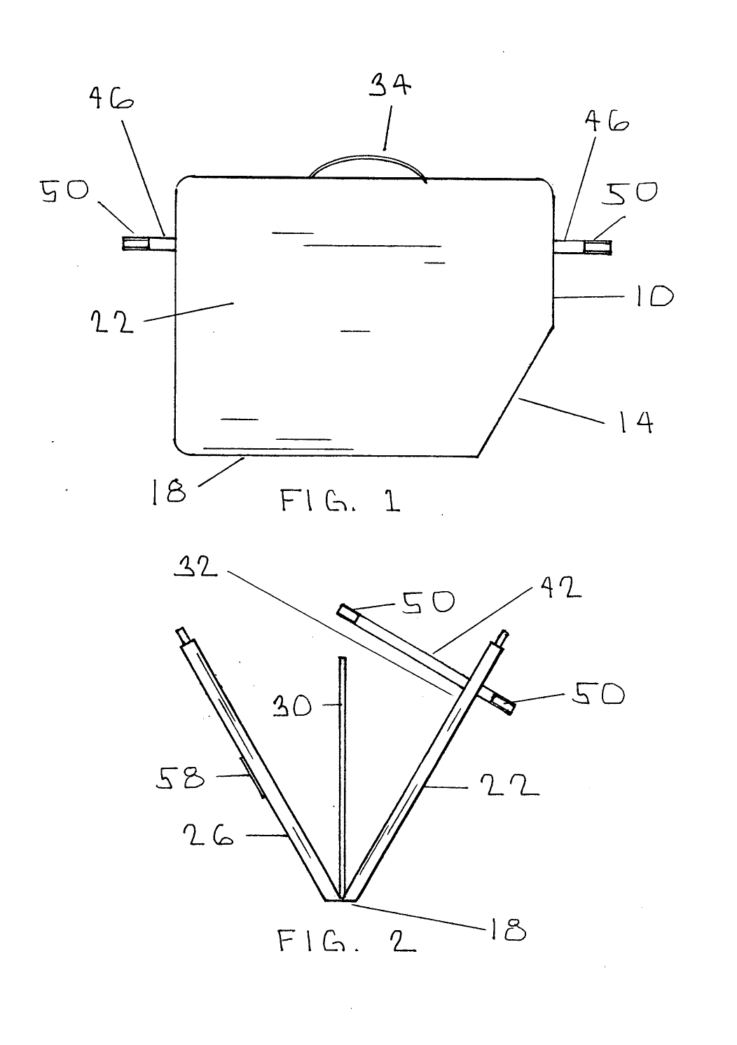

Referring to FIG. 1 in detail, reference character 10 generally indicates an elevation side view of the roof panel storage apparatus otherwise knows as the invention. The invention 10 shall have a triangular shape and construction complementary to the removable roof panels and additionally to the required disposition and placement within the rear storage area in a Jeep model vehicle.

Invention 10 having a frustrum 14 on the lower hinged portion 18. Said frustrum 14 comprising a cutaway section to fit around the speaker compartment within many Jeep vehicles. Invention 10 construction comprising a fabric like construction formed in a soft or semi-soft structure.

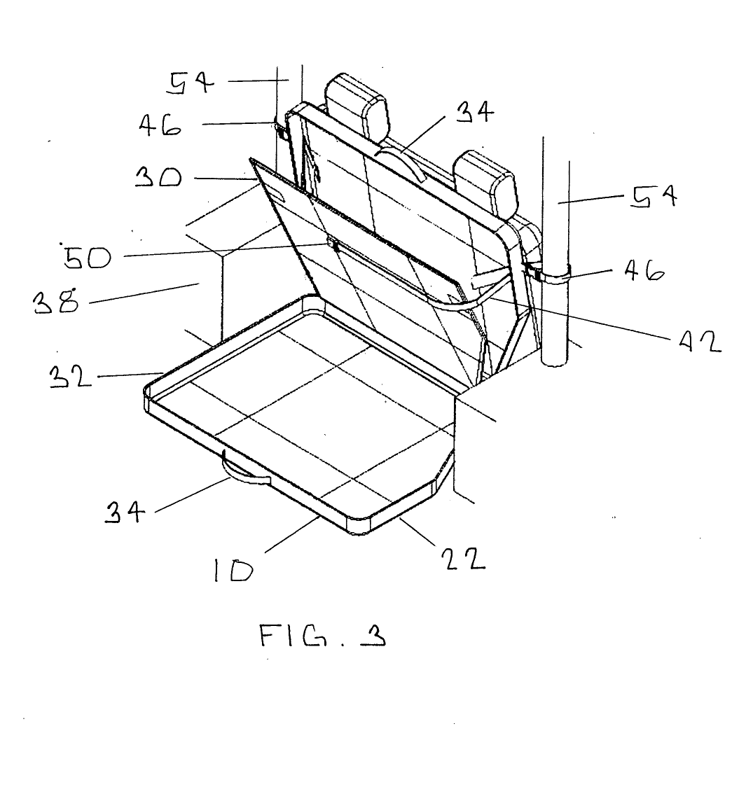

Invention 10 furthermore comprising a top section 22, a bottom section 26, and a centrally disposed semi-soft separation partition panel 30, better seen in FIG. 2 and 3. Partition 30 facilitating a protective cover to be sandwiched between the removable roof panels (Not Shown) to protect both removable roof panels from damage, such as scratches, dents, and abrasions. Partition 30

Said partition panel 30, top section 22 and bottom section 26 constructed from a protective fabric like material and may be a polymeric material, a textile material, or any other type of material that protects the removable roof panels. The exterior surfaces of the storage apparatus 10 may be covered with a protective material that protects the interior compartment of the Jeep 38 and the removable roof panels (Not Shown).

Said top section 22 and bottom section 26 furthermore having an engagements means that may include a zipper 32 or any closure means that may also include Velcro straps, snaps, ties, or overlapping or adhesive means.

The exterior surfaces of the roof panel storage apparatus 10 may be lined or covered with a protective material, such as fabric, cloth, carpet, pad, foam, cushion, or rubber. Preferably, the protective material matches the interior carpet and/or color of the automobile for an aesthetic appearance.

Both top section 22 and bottom section 26 having attached at the upper portion on each section a handle 34 facilitating a convenient carrying means. Said handle 34 may be constructed of a plastic, fabric, or rope like material. Top section 22 furthermore having centrally attached within the invention 10 a plurality of interior straps 42 for the purpose of securing and holding tight in placement a removable roof panel section as will be further explained later in more detail.

A second multiplicity of attachment straps 46 shall be attached externally to the proximity of the top section 22 of the invention 10 as will herein after be described. Said interior straps 42 and external straps 46 having an attachment, latching, or connection means 50 that may include but no be limited to Velcro, snaps or latches as required.

As illustrated in FIG. 3 the removable roof panel storage apparatus known as the invention 10 is operatively disposed within an interior compartment 38 of a Jeep vehicle. The invention 10 shall have a series of easily securing straps 46 that are operatively coupled to the roll bar 54. Velcro strips 58 are also utilized on exterior of the bottom section 26 for adhesion to the carpet material utilized on the back of the Jeep seats.

The removable roof panel storage apparatus 10 is designed and configured to generally conform to and frictionally engage the interior compartment of the Jeep interior 38. As a result, the interior compartment geometry and dimensions of the Jeep rear compartment will govern the overall size and shape of the storage apparatus 10.

The following detailed installation instructions will further describe and explain the operations of the removable roof panel storage apparatus 10 and furthermore detail the novel and unique approach that is apparent in the design and construction of the invention 10.

The operator will locate the two Velcro or like strips 58 on rear of the bottom section 26 and engage the Velcro with the carpet at the highest possible point on the back of the rear seat. The operator will then attach the two retaining straps 48 to the roll bars 54 located on either side of the rear seat. The straps are designed to go between the roll bars and the seat belts that run along the side of the roll bars.

The operator then opens the invention 10 by unzipping the bottom section 26 and the top section 22. The operator then unlatches the two retainer straps 42 allowing the invention 10 to open completely for inserting the removable roof panels.

The operator then places the driver side removable roof panel in the invention 10 and then secures the panel with the straps 42 to secure the panel in place. The separation panel 30 is then raised. Then the passenger side panel is placed in the invention 10 and secured in place with the straps 42 and the connectors 50.

The invention is then closed with the Zippers 32. The entire invention 10 holding the removable roof panels can then be easily removed if desired by releasing the two straps 46 and carrying the invention 10 with the two handles 34 at the top of the invention 10.

Another novel aspect of the invention is that when the removable rear seat is removed from the Jeep, the invention 10 can be mounted behind the front seats in the same manner and with the same connecting means utilizing the front roll bars.

The removable roof panel storage apparatus 10 in accordance with the present invention may readily be installed or removed from the Jeep without having to fasten or anchor the storage apparatus 10 in a fixed manner to the interior compartment. Further, it should be known that the storage apparatus 10 is designed and configured to store any removable roof panels of any suitable Jeep that come with removable roof panels.

It is to be understood that the present invention is not limited to the embodiments described above, but encompasses any and all embodiments within the scope of the following claims.

I claim:

1. A removable roof panel storage apparatus for Jeep removable roof sections, comprising: a semi soft storage container apparatus with support members separated by a centrally disposed spacer of a semi-soft panel to separate the removable roof panels furthermore having a plurality of straps and Velcro strips or other connection means attached to invention, designed and configured to conform to the interior compartment of a Jeep model vehicle and to securely hold the removable roof panels within the interior compartment and be adaptable to either front of back seat attachment and to furthermore have a means of carrying said roof panel away from the vehicle for external storage.

2. The storage apparatus according to claim 1, wherein the Velcro is replaced with tie offs.

3. The storage apparatus according to claim 1, wherein the Velcro is replaced with snaps.

4. The storage apparatus according to claim 1, wherein the Velcro is replaced with latching connectors.

5. The storage apparatus according to claim 1, wherein the Velcro is replaced with snap or like connectors.

6. The storage apparatus according to claim 1, wherein the body of the storage apparatus is constructed of a rigid material.

7. The storage apparatus according to claim 1, wherein the body of the storage apparatus is constructed of a plastic material.

8. The storage apparatus according to claim 1, wherein the body of the storage apparatus is constructed of a soft material without a rigid support frame.

9. The storage apparatus according to claim 1, wherein the body of the storage apparatus has extra storage compartments on the outside of the invention.

10. The storage apparatus according to claim 1, wherein the body of the storage apparatus has extra storage compartments on the inside of the invention.

11. The storage apparatus according to claim 1, wherein the central panel is removable.

12. The storage apparatus according to claim 1, wherein the body of the storage apparatus is constructed of a netting material.

13. The storage apparatus according to claim 1, wherein there are handles on each end and the top of the invention.

14. The storage apparatus according to claim 1, wherein the frustrum or sectional cut-away within the design is removed.

15. The storage apparatus according to claim 1, wherein there are no handles on the invention.

16. The storage apparatus according to claim 1, wherein there all edges are rounded.

17. The storage apparatus according to claim 1, wherein the frustrum or sectional cut-away within the design has rounded corners blending with straight edges.

18. The storage apparatus according to claim 1, wherein the invention is formed from one continuous piece of fabric material.
